(19) United States
(12) Patent Application Publication
(10) Pub. No.: US 2004/0054921 A1
(43) Pub. Date: Mar. 18, 2004

(54) Integrated monitoring and damage assessment system

(76) Inventor: H. Bruce Land III, Laurel, MD (US)

Correspondence Address: Benjamin Y Roca, The Johns Hopkins University, Applied Physics Laboratory, 11100 Johns Hopkins Road, Laurel, MD, 20723-6099, US

(21) Appl. No.: 10/398,886

(22) PCT Filed: Oct. 2, 2001
(86) PCT No.: PCT/US01/42449

(51) Int. Cl. G06F 11/30

(52) U.S. Cl. 713/200

(57) ABSTRACT

A computer network backbone system that provides integrated monitoring and damage assessment functionality. The system provides equipment and area monitoring functions for the purpose of detecting actual hazards and conditions that can lead to potential hazards. In the case of the detection of an actual hazard such as a fire or a gas leak, the system is capable of automatically triggering remedial measures such as cutting off power, releasing water or CO₂ to combat a fire, shutting off gas valves, etc. In the case of a potential hazard, such as items becoming overheated, or a rising water level, or an abnormal vibration pattern, the system can sound alarms and alert operators to a potentially hazardous condition. The system is configurable to integrate a multitude of sensor devices that monitor and respond to a variety of different conditions into a single computer backbone for processing by a single control unit. A single user interface that can be operated by single operator simplifies the operation of the system.

### CROSS REFERENCE TO RELATED APPLICATIONS

This application is related to and claims the benefit of U.S. Provisional Patent Application entitled, “Unmanned Spaces Monitoring System” Serial No. 60/238,969 and “Integrated Damage Assessment System” Serial No. 60/238,911, both filed Oct. 10, 2000.

### FIELD OF THE INVENTION

The present invention is related to a computer network backbone providing an integrated monitoring and damage assessment system (IMDAS). More particularly, the present invention is an integrated monitoring and damage assessment system for unmanned or lightly manned spaces employing heavy equipment or machinery such as large power systems, computer farms, complex plant facilities, and the like.

### BACKGROUND

In the late 1970s the Navy recognized that electrical fires were becoming a major problem in submarines. Approximately three fires per year were occurring in the main electrical distribution switchboards across the submarine fleet. These fires have a major impact on mission readiness and could potentially cause loss of life and ship. In three-quarters of a second, the current from the smallest shipboard generator can cause an arc fault capable of burning a fist-sized hole in the side of an electrical power switchboard.

Main shipboard power switchboards, for instance, conduct thousands of amps over bare copper bus bar 1-12 inches wide and 0.25-1 inch thick. Over a hundred of these switchboards can exist on a single ship. Large circuit breakers control the flow of current to remote loads and smaller switchboards. An arc fault of several hundred amps can exist and not cause a breaker to open since normal loads draw much more current. An arc fault is not a short across the circuit, but rather a resistive load yielding heat; therefore, the breakers do not open. Faulty connections due to corrosion, faulty initial fastening, vibration, etc., cause 60-80% of arc faults. Contamination and foreign objects can also cause arc faults.

The foregoing is but one example of a situation where an integrated monitoring and damage assessment system would be of great value. Other facilities that would greatly benefit from an integrated monitoring and damage assessment system include large ships and planes, buildings that host computer farms, large hotels and office buildings having internal plant facilities, buildings that house large manufacturing processes, hospitals, and many more.

What is needed is monitoring and damage assessment system that can be implemented with minimum impact on the facilities/equipment being monitored yet have maximum flexibility to monitor and respond to a variety of potentially dangerous conditions.

### SUMMARY

The present invention is a computer network backbone providing an integrated monitoring and damage assessment system. The system provides equipment and area monitoring functions for the purpose of detecting actual hazards and conditions that can lead to potential hazards. In the case of the detection of an actual hazard such as a fire or a gas leak, the system is capable of automatically triggering remedial measures such as cutting off power, releasing water or CO₂ to combat a fire, shutting off gas valves, etc. In the case of a potential hazard, such as items becoming overheated, or a rising water level, or an abnormal vibration pattern, the system can sound alarms and alert operators to a potentially hazardous condition.

The value of the present invention is its ability to be configured to integrate a multitude of sensor devices into a single computer backbone for processing by a single control unit. Heretofore, standalone systems existed to monitor for and react to various conditions. However, these systems were not integrated with one another which meant that an operator was needed for each system. Or, a single operator might be responsible for several systems that have a completely different look and feel. Moreover, the infrastructure and wiring required for several systems can create problems in many instances. The present invention alleviates the above mentioned shortcomings by using a single computer backbone to integrate a variety of different sensors that monitor and respond to a variety of different conditions. A single user interface that can be operated by a single operator simplifies the operation of the system.

The present invention (IMDAS) can do more than just monitor and inform of actual or potential problems. The IMDAS can be configured to take automatic remedial measures upon detection of certain conditions. Moreover, the IMDAS is equipped to perform system-wide, and in most cases, sensor-wide built-in-testing.

The present invention includes at least one sensor interface module (SIM), preferably more, having a plurality of sensor inputs for detecting the levels of, for example, water, carbon monoxide, light, noise, oxygen, smoke, toxic gases, air temperature, combustibles, and more. The primary function of a SIM is to multiplex the various sensor signals it receives onto a common bus for delivery to a control unit. Another SIM function is performing periodic built-in-testing of the sensors. Typically, the SIMs are configured with the normal operating parameters of the environment that their sensors are in and will only report detected events to the control unit that are out of the ordinary. The control unit can control the SIMs to report all data if desired such as during a system test or when something out of the ordinary has been detected.

Numerous SIMs are daisy chained together throughout protected, confined, compartmentalized, or unmanned areas. SIMs can be grouped into zones. SIM signals are then sent to a control unit (CU) which provides a warning of some type, such as an alarm, flashing light, etc., when a fault is detected by any of the sensors. The control unit can also take remedial action automatically in order to eliminate any operator delay which could exacerbate a particular situation. The control unit is networked with the SIMs such that each zone is accorded a connection to the control unit.

Some sensors are used primarily to determine the condition of the area where a potential problem exists in order to determine whether it is safe for human entry. For instance, smoke, carbon monoxide, low oxygen, temperature are factors that could prevent a person from entering an area. Environmental sensors provide data through the SIM to the control unit alerting an operator of current conditions in an affected area.

The control unit also provides an interface for connecting to existing safety devices such as sprinklers, valves, or breakers, so that remedial measures can be immediately commenced. The control unit can also be connected with an external computer network via an interface so that data and test results can be logged, alarms can be sent to other computers to alert other personnel, or emergency personnel can be summoned.

### BRIEF DESCRIPTION OF THE DRAWINGS

FIG. 1 is a block diagram of the system according to the present invention.

### DETAILED DESCRIPTION

The present invention is a computer network backbone providing an integrated monitoring and damage assessment system (IMDAS). The IMDAS provides equipment and area monitoring functions for the purpose of detecting actual hazards and conditions that can lead to potential hazards. The IMDAS computer network backbone comprises a control unit that receives and responds to sensor data, sensor interface module(s) (SIMs) operatively connected with the control unit, and sensor(s) operatively connected with the SIMs wherein the sensor(s) monitor a variety of spaces and equipment for a variety of conditions. The SIMs receive data from the sensor(s) and multiplex the sensor data onto a common bus for delivery to the control unit for processing.

Control unit processing includes the ability to automatically take remedial measures to affected areas immediately upon detection of an abnormal condition. The IMDAS computer network backbone also provides connections with alarm means that can be operatively coupled with the control unit such that an alarm can be issued if the control unit receives data from the sensor(s) that indicate an abnormal condition. The alarm means can be audible or visual or any combination of the two including sirens, flashing lights, and screen displays on operator terminals.

Built-in-testing functions are included for the individual sensors and the system as a whole in order to ensure that the system is operational and that the sensors are all on-line and properly functioning.

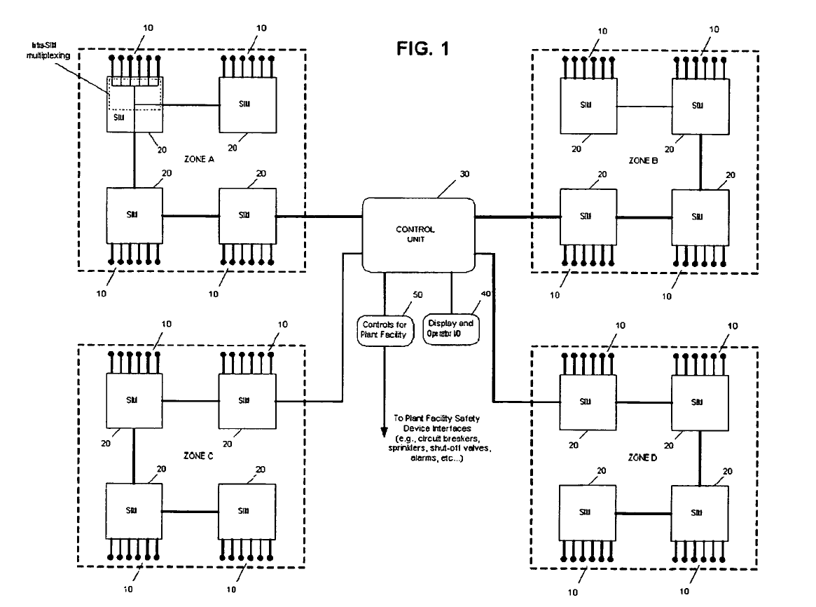

FIG. 1 illustrates a block diagram of the IMDAS computer network backbone which is comprised of various sets of sensors 10 connected with a plurality of sensor interface modules (SIMs) 20. A control unit 30 receives sensor data from the SIMs 20 and can provide display and operator I/O means 40 for operators. In addition, control unit 30 is also operatively connected with a control means 50 that allows the IMDAS computer network backbone to be connected with an external computer network or directly with plant facility safety devices such as sprinklers, circuit breakers, gas valves, smoke alarms, etc. Such a connection allows the IMDAS computer network backbone to immediately respond to abnormal conditions when appropriate.

The number of sensors per SIM, the number of SIMs per zone, and the number of zones per control unit is variable and will depend in large part on the complexity of the equipment and area that are to be monitored. For purposes of illustration only, FIG. 1 shows six sensors per SIM, four SIMs per zone, and four zones per control unit. These numbers can readily be altered in whole or in part to suit the needs of a given application. Any such deviation does not depart from the spirit or scope of the present invention.

The SIMs 20 are connected to each other in a single daisy chain per zone and back to the control unit 30. The primary function of a SIM 20 is to multiplex the various sensor signals it receives onto a common bus for delivery to a control unit 30. Another SIM function is performing periodic built-in-testing of the sensors. Typically, the SIMs 20 are configured with the normal operating parameters of the environment that their sensors are in and will only report detected events to the control unit 30 that are out of the ordinary. The control unit 30 can control the SIMs 20 to report all data if desired such as during a system test or when something out of the ordinary has been detected by one or more sensors 10.

All SIMs 20 continuously monitor the sensors for any activity that would be considered out of the ordinary. Since each SIM has been configured with the expected pattern or range of acceptable sensor readings, an abnormal event is easily identifiable. Should such an abnormal event be detected, a SIM 20 will report its location and the reporting sensors 10 to the control unit 30 which will immediately take the appropriate remedial measures as well as trigger the appropriate alarm(s). The affected location (zone/SIM) and the reporting sensor(s) are saved in a file and the location is displayed on the display.

Each zone has a direct network connection with the control unit 30 creating a network structure that is a generic network backbone for monitoring and assessing potential problems related to equipment and areas such as those found on military or commercial ships, hotels, stadiums, manufacturing plants, etc. The control unit 30 also supplies power to the network of SIMs 20 and sensors 10.

The generic backbone can be implemented with a variety of special purpose sensors 10 to fit the needs of virtually any monitoring situation. Special purpose sensors 10 include, but are not limited to, sensors that detect air temperature, water levels, carbon monoxide levels, toxic gas levels, changes in light, changes in noise, oxygen levels, smoke, and combustible toxins. Each SIM 20 can support a plurality of different sensors 10. Sensor data is multiplexed onto a common bus and passed from the SIM 20 to the control unit 30 where it is automatically and continuously processed. Anomalies, errors, faults, or other negative events that are detected can be made known via display/IO means 40. Forms of alerts can be visual (screen output, flashing lights) or audible (alarms, verbal warnings). In addition, control unit 30 can be programmed to respond to certain events automatically in an effort to minimize damage.

The physical connection from sensor 10 to SIM 20 to control unit 30 will depend on the environment of the deployed system. The connection(s) can be hard wired, wireless, or a combination of the two. Hard wired connections can vary depending on the anticipated environment of the system and the number of sensors 10 and SIMs 20 being used.

One wiring implementation provides for a three twisted shielded pair cable to be used for the network cable. All sensor data would arrive via a sensor bus over a two wire RS-485 interface. Two pairs of the cable would supply redundant power to all of the SIMs 20.

The present invention includes two modes of operation, a monitoring mode and a maintenance mode. Monitoring mode is when the system is up and running normally while maintenance mode is reserved for the running of system-wide and/or sensor-wide built-in-testing. A total system BIT (Built-In-Test) can be performed from the control unit 30 upon operator request. Or it can be automatically scheduled. For maintenance purposes a separate BIT capability exists which allows for the testing of specific components for a specific zone. Tests are available for trip relay continuity, the network power, the SIMs and sensors, as well as any alarms. An hourly BIT of the network power to the SIMs can be performed before reading the sensor temperatures. Exiting maintenance mode causes a total system BIT before returning to monitor mode to ensure that software configuration or installation changes made reflect the hardware present and the operating state of that hardware.

The rest of the description presents several scenarios, types of equipment, types of areas, or potential hazards that the present invention can be configured to monitor for and protect against. What follows is illustrative only and is not intended to be all inclusive. One of ordinary skill in the art can readily extend the concepts discussed herein and apply the present invention to other types of equipment, areas, or potential hazards.

### Arc Fault Detection and Protection

Arc fault detection is one application for the present invention. As earlier described, arc faults pose a significant and dangerous risk for large power distribution systems. The ability to detect and extinguish arc faults in a matter of microseconds is critical to minimize the potentially devastating damage they can cause. Arc faults are detected by a combination of a change in light, a change in pressure, and sometimes from the release of very small particles due to burning insulation

Photosensors represent one form of sensor used for arc fault detection. The photosensors detect light emitted by an arc fault and reports to the SIM 20. Amplifiers in the photosensors arc set to produce a signal of zero to five volts When a photosensor is directly exposed to ambient compartment lighting the combination of selective coatings on the lens and the gain settings keeps the photosensor signal to approximately 0.3 volt while an arc will cause the output to saturate at five (5) volts.

One type of photosensor contains a narrow-band ultraviolet filter to prevent false triggering of the photosensor from other light sources. LEDs are mounted inside of the hermetically sealed photosensor. During built-in-testing (BIT), the light from several infrared LEDs inside of the photosensor is bounced off the back surface of the photosensor lens and back in to the detector. The SIM 20 measures the analog value to check for proper sensor operation. At least one photosensor must pass BIT for proper SIM operation. Each photosensor also contains a solid-state temperature device and its temperature is read by the SIM 20 once per hour upon request by the control unit 30.

Another type of arc fault sensor is the thermal ionization detector (TID). A thermal ionization detector detects small particles released into the air from overheated cables or from Glyptal-coated bus bar junctions. Overheated insulation can be detected at 200-300° C., well below the 1083° C. needed to melt copper and cause an arc fault. The detection of an overheated connection results in an alarm and does not open breakers. The alarm alerts the operator to quickly reroute power around the affected switchboard and to inspect the switchboard for a faulty connection or component. Analysis of fire reports has shown that sixty to eighty percent of all switchboard fires are cause by an overheated connection. TIDs allow the present invention to predict most arc faults in time to prevent them from happening.

Each TID contains two polarized electrodes through which the ambient air passes due to convection. Alpha particles are emitted that cause a current of approximately 20 pA to flow to a collector electrode. This current is then fed into a high gain amplifier. The small particles generated by overheating insulation soak up electrons and upset the balance of the amplifier. The normal output of the amplifier is seven to ten volts. When the particles are present the output sinks to approximately three volts. During built-in-testing, the SIM 20 polarizes a test electrode. This soaks up electrons much as the emitted particles do and creates a similar output. This allows an end-to-end test of the TID. TIDs also contain a solid-state temperature device and their temperature is logged once per hour by the control unit 30.

Arcs create heat as well as light. Once a full power arc is created, the air within the switchboard is rapidly heated and the switchboard vents cannot relieve the pressure wave. A high-speed pressure switch, inside of a pressure sensor, closes if the pressure inside the switchboard exceeds that outside of the switchboard. Solid-state switches inside a pressure transducer housing allow an end-to-end test to be conducted when the central control unit performs the built-in-testing.

The photosensors, TIDs, and pressure switches produce low-level signals. These low-level signals must be reliably detected and quantified inside of switchboards in the presence of electromagnetic interference (EMI) signals from the large AC loads that are frequently switched. When dealing with the main power system for a ship, for instance, a prime directive is that no false alarms are acceptable. Signals from photosensors are voltage related, while the signals from the pressures sensors are current based. Fifteen-volt logic was chosen as the most noise immune logic. Complimentary voltage signals were chosen for the photosensor to make them ignore common mode noise. Twisted shielded pair cable was used to further reduce noise susceptibility.

The logic inside of the control unit takes additional steps to assist in ignoring false signals. Digital filters are incorporated to qualify that signals are neither too short nor too long in duration. Signals from the photosensor and the pressure sensor must exist within the proper timing of each other to be considered valid arc signals. The control unit logic is designed so that no single point failure of the system can cause it to erroneously open breakers.

Breakers that can cut off the flow of current to protected switchboards are identified upstream of the protected switchboards. Because many switchboards have common feeds, removing power from one entails removing power from several. Since the operation of almost everything on a ship depends on electricity, zones of protection are defined to allow any switchboard sustaining an arc to be isolated while a minimum number of other switchboards are affected. When a valid arc is recognized, the appropriate breakers are tripped. If the breakers are tripped within less than 0.25 second, the damage will be limited to smoke damage and major repairs will likely not be needed.

After circuit breakers have been automatically tripped by the present invention, the system can take other remedial measures such as discharging CO₂ into the switchboard to extinguish residual fires on cable insulation. Local and/or remote alarms are set off to inform operators as to the location of the affected power switchboard. Moreover, the control unit 30 can put out an alarm over a network interface to inform responsible personnel as to the nature and location of the problem in order to have repairs performed in the most expeditious manner. Knowing the exact location of the problem as soon as possible greatly assists in bringing the power systems back on-line in the shortest amount of time.

If a TID reports a potential arc fault, then the ensuing alarms can alert an operator that a conditions for an arc may be forming. This would allow the operator to take preventive action prior to the occurrence of a damaging arc fault. Such action could include re-routing power around the problem area and having responsible personnel examine and repair the power switchboard.

With the advent of solid-state power converters, capacitor banks have received new recognition as a problem area in electrical systems. When capacitors fail due to a short, they tend to violently eject conductive material. The ejected material can cause arcing across the terminals of the capacitor bank. These arcs can reach thousands of amps and can quickly destroy the equipment. Typically these capacitor banks are tightly packed and photosensors do not have the wide view they need for peak functionality. A fiberoptic based arc fault detector that is well suited for capacitor banks has also been developed and is suitable for use with the present invention. The small size of the fiber allows it to be easily routed throughout the capacitor bank to obtain full coverage.

### Toxic/Flammable Gas Monitoring

Semiconductor fabrication plants require complex machinery. Additionally, dangerous materials such as toxic gases are used in the fabrication process. These materials are typically stored on-site in separate rooms. Some of the SIM zones could cover power switchboards for arc faults as previously described. Other SIM zones could cover the facility rooms that contain bottled gas supplies. A leak of a toxic or flammable gas could occur in a normally unmanned room. The system would have sensors and SIMs in such a room for the express purpose of measuring the levels of those gases in the atmosphere. Upon detection of an unusual level of gas, the control unit would, inter alia, shut off the supply valve for the appropriate gas, send an alarm to a remote monitoring location, turn on ventilation fans, notify an emergency response team as to the type of leak that would allow them to enter the room with the appropriate breathing equipment, and supply updated notification(s) as to when the room has been ventilated to a safe level for entry.

If a fire were to break out in a monitored room it would be detected by sensors that monitor changes in light, temperature, and/or the smoke. The control unit would turn on fire suppression systems and send local, remote, and network alarms to the appropriate destinations. Moreover, here are different levels of fire that require different levels of automatic response. For instance, if the temperature in a closed room reaches a certain level and the oxygen content in the room is low, then the system would alert response personnel not to open a door to the room, as the sudden entrance of oxygen would create a back draft that would likely kill the people at the door.

### Vibration Monitoring

There is always a normal background vibration in a room or compartment. The vibration pattern can be detected by an accelerometer and quantified based upon its frequency and amplitude. The baseline vibration pattern would be stored by a local SIM shortly after installation. If a pump, motor, or other equipment associated with the generation of compressed air, vacuum, or water distribution were to develop problems with bearings, for instance, it would affect the vibration signature of the room. The SIM would detect the change in vibration readings provided by the accelerometer and alert the control unit of a potential problem. The control unit could then furnish local, remote, and network alarms or turn off any equipment depending upon the severity of the signature deviation.

### Water Level Monitoring

Most large compressors and vacuum pumps are water-cooled. A water level detector on the floor of a room would monitor for possible leaks in the water system. Upon detection of excess water, the control unit could turn off the water supply and pump to prevent water damage and damage to the pump due to insufficient water supply.

### Explosion Detection

If there were a sudden explosion in a room it likely would not be detected by conventional fire alarm systems unless a fire accompanied it. The present invention can utilize sensors that would detect a flash of light, a sudden change in background noise, and a sudden spike of the baseline vibration signal. The control unit could shut down all utilities that pass through the room that created the alarms. A system message such as “Explosion due to unknown reasons” could be sent out to appropriate destinations.

### Security Monitoring

For secure areas the present invention could monitor for the opening of doors or the breaking of glass via door switches, changes in noise, and changes in light. This information would be passed to the control unit which could furnish an alert to an appropriate destination. Security measures outside the door that authorize entry into such a room could be configured to override the door alarm upon a valid opening of the door.

### General Applications of the Above

The facility equipment rooms for a hospital, Internet hosting firm, or general manufacturing facility would have use for many, if not all, of the above monitoring scenarios. An Internet hosting firm, for instance, is typically a large windowless building with many secure rooms. Each secure room has hundreds of computers that host information and respond to thousands of requests for information over the Internet. AC power is brought into the building from two different sets of high voltage power lines so that if one set is disabled, it does not cause power to fail in the second set. In addition, there is generally a local diesel power generator for emergency backup. In the equipment room there is a high speed AC switch that can sense the loss of power from one feed and switch to the second feed without loosing power long enough to crash the computers in the building.

Arc fault detection is clearly needed to protect the power switchboards. If a TID detects a faulty connection, the control unit can route power to a backup source without interruption and repair the problem. Otherwise, a switchboard problem can shut down all of their backups at once leaving the computers inaccessible to the Internet.

The computer rooms are unmanned and have use for the general monitoring functions described previously. There is a need to monitor for the usual smoke and fire, but loss of air conditioning could damage the computers as well and thus ambient room temperature needs to be monitored. Fire suppression systems for use with electrical equipment typically discharge CO₂ not water. Therefore the system needs to know people are out of the room before discharging the gas. Once the fire is out the room must be ventilated before it is safe for people to re-enter the room.

The present invention approach is to integrate of all of the aforementioned monitoring scenarios into a single system that can perform detection, alarm, reporting, and response functions that respond to detected events in proportion to the severity and nature of the detected event. In many cases the present invention can monitor normal background conditions and thus learn what comprises a faulty condition.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed:

1. A computer network backbone that provides monitoring and damage assessment functionality in order to detect and respond to abnormal events that may occur to a variety of equipment or devices, or occur in a variety of spaces including typically unmanned rooms or compartments, said computer network backbone comprising:
a control unit having processing and communication capabilities, said control unit for receiving and responding to sensor data;
a sensor interface module (SIM) operatively connected with said control unit; and
a plurality of sensors operatively connected with said SIM wherein said sensors are responsible for monitoring for abnormal conditions,
wherein said SIM receives sensor data from said sensors and multiplexes said sensor data onto a common bus for delivery to said control unit for processing.

2. The computer network backbone of claim 1 wherein said processing includes responding to a detected abnormal condition by taking immediate remedial action to neutralize the abnormal condition or minimize the effect of the abnormal condition.

3. The computer network backbone of claim 3 wherein with said control unit is operatively coupled with alarm means such that an alarm can be issued if said control unit receives sensor data that indicates an abnormal condition.

4. The computer network backbone of claim 3 wherein said alarm means is comprised of at least one audible alarm.

5. The computer network backbone of claim 3 wherein said alarm means is comprised of at least one visual alarm.

6. The computer network backbone of claim 1 wherein said control unit further comprises an interface for connecting with external devices such that an alarm can be issued via said external devices if said control unit receives sensor data that indicates an abnormal condition.

7. The computer network backbone of claim 1 wherein said control unit further comprises an interface for connecting with external devices such that immediate remedial action can be taken to neutralize an abnormal condition or minimize the effect of an abnormal condition if said control unit receives sensor data that indicates an abnormal condition.

8. The computer network backbone of claim 1 wherein said sensors include a photosensor for detecting changes in light.

9. The computer network backbone of claim 8 wherein said photosensor is periodically tested to verify that it is functioning properly.

10. The computer network backbone of claim 1 wherein said sensors include a thermal ionization detector for detecting electron levels that are altered when small particles are released into air.

11. The computer network backbone of claim 10 wherein said thermal ionization detector is periodically tested to verify that it is functioning properly.

12. The computer network backbone of claim 1 wherein said sensors include a pressure sensor that detects whether the air pressure within an enclosed area exceeds the pressure outside of said enclosed area.

13. The computer network backbone of claim 12 wherein said pressure sensor is periodically tested to verify that it is functioning properly.

14. The computer network backbone of claim 1 wherein said sensors include a smoke detector for detecting smoke in a confined area.

15. The computer network backbone of claim 14 wherein said smoke detector is periodically tested to verify that it is functioning properly.

16. The computer network backbone of claim 1 wherein said sensors include a toxic gas sensor for detecting toxic gases in a confined area.

17. The computer network backbone of claim 16 wherein said toxic gas sensor is periodically tested to verify that it is functioning properly.

18. The computer network backbone of claim 1 wherein said sensors include an accelerometer for detecting vibrations in a confined area.

19. The computer network backbone of claim 18 wherein said accelerometer is periodically tested to verify that it is functioning properly.

20. A computer network backbone that provides monitoring and damage assessment functionality in order to detect and respond to abnormal events that may occur to a variety of equipment or devices, or occur in a variety of spaces including typically unmanned rooms or compartments, said computer network backbone comprising:
a control unit having processing and communication capabilities, said control unit for receiving and responding to sensor data;
a plurality of sensor interface modules (SIMs) that receive sensor data, said SIMs operatively connected with said control unit; and
a plurality of sensors per SIM operatively connected with said SIM, wherein
said sensors are responsible for monitoring for abnormal conditions,
said sensors include a photosensor for detecting changes in light, a thermal ionization detector (TID) for detecting electron levels that are altered when small particles are released into air, a pressure sensor, a smoke detector, a toxic gas sensor, and an accelerometer, and
said SIMs multiplex said sensor data onto a common bus for delivery to said control unit for processing wherein said processing includes responding to a detected abnormal condition by taking immediate remedial action to neutralize the abnormal condition or minimize the effect of the abnormal condition.

21. A method of providing centralized monitoring and damage assessment functionality in order to detect and respond to abnormal events that may occur to a variety of equipment or devices, or occur in a variety of spaces including typically unmanned rooms or compartments, said method comprising:
placing a plurality of sensors that are capable of detecting a variety of different conditions about an area to be monitored and on machinery to be monitored;
having a set of said sensors feed into a sensor interface module where the sensor data obtained by said sensors is multiplexed onto a common bus;
forwarding said multiplexed sensor data from said sensor interface module to a control unit where said sensor data is processed by said control unit, said control unit being operatively connected with and having the ability to control a variety of safety devices and mechanisms such that when an abnormal event is detected remedial action is taken by having said control unit trigger the appropriate safety device or mechanism to minimize or eliminate the abnormal event.

22. The method of claim 21 wherein further comprising having said control unit issue an alarm when an abnormal event is detected
